(19) United States
(12) Patent Application Publication
(10) Pub. No.: US 2021/0401233 A1
(43) Pub. Date: Dec. 30, 2021

(54) Grilling and Cooking Spatula Device

(71) Applicant: Nola Nevers, Seattle, WA (US)

(72) Inventor: Nola Nevers, Seattle, WA (US)

(21) Appl. No.: 17/358,607

(22) Filed: Jun. 25, 2021

Related U.S. Application Data
(60) Provisional application No. 63/045,260, filed on Jun. 29, 2020.

(51) Int. Cl. A47J 43/28; A47J 37/07

(52) U.S. Cl. CPC A47J 43/288; A47J 43/283; A47J 37/0786

(57) ABSTRACT

The present invention relates to a grilling and cooking spatula device. The spatula device easily flips and lifts delicate food items from a cooking surface without breakage and/or slippage. The spatula device includes a handle and a slightly curved spatula plate having a beveled edge and a large curvilinear surface. More specifically, the handle is generally cylindrical having a mounting groove and a pair of ergonomic grips near the ends of the handle for comfortable gripping. The spatula plate is generally rectangular and includes a continuous curvilinear sheet. A top lateral edge of the plate is fastened within the handle. The beveled leading edge of the spatula plate is used for slipping between a food item and a cooking surface thereby enabling the food item to be slid onto the spatula plate.

### CROSS-REFERENCE TO RELATED APPLICATION

The present application claims priority to, and the benefit of, U.S. Provisional Application No. 63/045,260, which was filed on Jun. 29, 2020 and is incorporated herein by reference in its entirety.

### FIELD OF THE INVENTION

The present invention relates generally to the field of food-handling utensils. More specifically, the present invention relates to a multi-purpose utensil for grilling and serving fish and other delicate food items. The grilling utensil enables food items to be easily lifted off of the grill and flipped thereon. The utensil includes a modified beveled spatula edge. The beveled spatula structure ensures that the cook or chef can slide the utensil underneath the delicate food items on the grill and flip them easily without damaging or breaking the delicate food items. Additionally, the modified spatula can be used conveniently to transfer cooked food from the grill to a serving platter. In this manner, the multipurpose utensil of the present invention eliminates the need to use a spatula, or a pair of conventional spatulas, to flip fish and other delicate food items, or to transfer food items from one place to another. Accordingly, the present disclosure makes specific reference thereto. Nonetheless, it is to be appreciated that aspects of the present invention are also equally applicable to other like applications, devices, and methods of manufacture.

### BACKGROUND OF THE INVENTION

By way of background, barbecuing or grilling food allows a wide range of food items to be cooked, such as vegetables and meat, including beef, chicken, fish, pork, etc. Grilled food includes various health benefits over traditional cooking methods, and therefore has become increasingly popular among the general population. Typically, individuals keep barbeque grills at home to easily grill food items and enjoy grilled food. Nowadays, even commercial restaurants offer an increasing number of grilled menu items to fulfil the cravings of their patrons.

Typically, barbeque grills comprise a firebox having a cooking grate suspended over a source of heat. Food items such as vegetables or meat, including fish, chicken, and more can be placed on the cooking grate. Various kinds of utensils or cooking tools such as spatulas, tongs, forks, and others can be used for flipping, turning, searing, removing, i.e. generally handling and cooking the food. Some of the cooking tools, such as spatulas, are used to flip or turn the food item over and to place the same back onto the cooking surface or grate, and other tools are particularly adapted for removing or placing food items, such as for removal or placement of food items onto the grill. Use of multiple cooking tools for flipping delicate food items such as fish, or the like, and transferring the cooked food items to a serving platter, can be extremely cumbersome and difficult.

Individuals can use a single spatula or a pair of spatulas to flip food, but despite being careful, delicate food items may break apart and look unappetizing once the food is cooked. Additionally, when the cooked food is to be served, transferring the food item to a serving platter may be difficult with a single spatula and can cause the food item to fall apart when the food item is transferred to the serving platter. This situation is particularly acute when the food item is larger than the spatula(s). The result not only ruins expensive food items, but can also cause the users to have to restart the cooking process from scratch, making the grilled cooking a time-consuming process. Food items that fall apart are unappetizing at best and inedible at worst.

Therefore, there exists a long felt need in the art for a utensil that allows the users to easily grill food items such as vegetables, meat, beef, chicken, fish, shrimp, pork, etc. There is also a long felt need in the art for a cooking tool that allows the users to handle and manage delicate food items, such as fish, without worrying about the food item breaking apart during handling while grilling. Additionally, there is a long felt need in the art for a cooking utensil for handling grilled food that prevents the delicate food items from breaking apart while flipping or turning the food items on the cooking grate or while removing the food items from the grate. Moreover, there is a long felt need in the art for a cooking utensil that allows the users to easily transfer the cooked food item from the cooking grill to a serving platter without the food item separating, thereby preventing any wastage of cooked food. Further, there is a long felt need in the art for a cooking tool that allows the users to quickly cook food and transfer the same onto the serving platter while ensuring the cooked food items look appealing to the consumers. Furthermore, there is a long felt need in the art for a cooking tool that eliminates the need to use multiple cooking utensils for managing and handling grilled food. Finally, there is a long felt need in the art for a cooking tool that can be used for flipping grilled food items and for easily transferring cooked food items from the grill to the serving platter.

The subject matter disclosed and claimed herein, in one embodiment thereof, comprises a grilling and cooking spatula device. The grilling and cooking spatula device is configured to easily flip and lift delicate food items from a cooking surface. The spatula device further comprises: a handle and a convex arc-shaped or curvilinear spatula plate; the handle is generally cylindrical having a slit on a front side and a pair of ergonomic grips near the ends of the handle for comfortable gripping of the handle; the spatula plate is generally rectilinear in dimensions and includes a continuous curvilinear sheet; the spatula plate includes a pair of longitudinal edges, a top lateral edge and a bottom beveled edge; the top lateral edge is fastened within the handle using rivets allowing use of the spatula plate; and, the bottom beveled edge is used for sliding under a food item placed on a cooking surface allowing the food item to be slide onto the continuous curvilinear sheet. The handle can be made of a heat-resistant material and the spatula plate can be made of thermostat materials, i.e. stainless steel.

In this manner, the novel grilling and cooking spatula device of the present invention accomplishes all of the forgoing objectives and provides a relatively easy and convenient solution to manage and handle food items while grilling, cooking and serving. The grilling and cooking spatula device of the present invention is also user-friendly, as it allows the users to use a single device to flip or turn food items while grilling, and for transferring the food items from the cooking grate to a serving platter once the food is cooked. The grilling and cooking spatula device eliminates the need to use multiple spatulas or cooking tools for handling food items while barbecuing, heating or grilling. Additionally, the grilling, cooking, and/or heating spatula device prevents the delicate food items from breaking apart while flipping or turning, and ensures the cooked food items appear appealing when served.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a grilling and cooking spatula device. The grilling and cooking spatula device is configured to easily flip and lift delicate food items from a cooking surface. The spatula device further comprises: a handle and a convex arc-shaped or curvilinear spatula plate; the handle is generally cylindrical having a slit on a front side and a pair of ergonomic grips near the ends of the handle for comfortable gripping of the handle; the spatula plate is generally rectilinear in dimensions and includes a continuous curvilinear sheet; the spatula plate includes a pair of longitudinal edges, a top lateral edge and a bottom beveled edge; the top lateral edge is fastened within the handle using rivets allowing use of the spatula plate; and, the bottom beveled edge is used for sliding under a food item placed on a cooking surface allowing the food item to be slide onto the continuous curvilinear sheet. The handle can be made of a heat-resistant material and the spatula plate can be made of thermostat materials, i.e. stainless steel and aluminum.

In a further embodiment of the present invention, a spatula device with curved plate is disclosed. The spatula device can include a heat-resistant or oven-proof handle, and a thin curved spatula plate attached to the handle. The handle includes a slit, and the spatula plate extends from the slit. The spatula plate includes a beveled leading edge designed to slide under a delicate food item allowing the food item to slip onto the continuous curvilinear surface of the thin curved spatula plate. When the spatula device is placed on a flat surface, the handle and the beveled edge remain above the flat surface, while the central portion of the spatula plate touches the flat surface.

In a further embodiment of the present invention, the spatula device conveniently transfers food from a cooking surface such as a grill to a serving platter. As described herein, the single spatula device provides an enlarged surface area for flipping and transferring delicate and large food items such as, for example, a fish, a steak, a group of shrimp and/or a group of vegetables. The top handle can be heat-resistant (i.e. oven-proof) and offers a convenient and alternative operation of the device. In one alternative embodiment, the spatula device can be placed directly on the grill to act as a cooking surface wherein the food to be cooked is placed on an upper surface of the spatula plate. The food is left on the upper surface and the spatula device is placed directly on the grill for a duration sufficient to cook the food thereon.

In yet a further embodiment of the present invention, the beveled edge of the spatula plate can be slid under a large delicate food item, and the enlarged curvilinear surface enables flipping or turning of the large delicate food item (or groups of delicate food items) by providing complete support thereunder without any breakage or slippage. The spatula or flipper device can be available in a kit with gourmet rubs, marinades and recipes.

In a further embodiment of the present invention, a gourmet kit is disclosed. The gourmet kit includes gourmet rubs, marinades, and a large curvilinear flipping or cooking spatula. The flipping or cooking spatula device includes an insulated handle and an attached spatula plate. The spatula plate includes a generally rectangular curvilinear surface and a beveled leading edge. The beveled leading edge is configured to slide under a food item, such as a piece of fish seared to a grill, and then separate and lift the complete food item off of the grill in a two-handed manner using the cylindrical and elongated handle that reduces the chances of the delicate food item from coming apart.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a grilling and cooking spatula device of the present invention in accordance with the disclosed architecture;

FIG. 2 illustrates a perspective view of a heat resistant handle of the grilling and cooking spatula device of the present invention in accordance with the disclosed architecture;

FIG. 3 illustrates a perspective view of a user using one potential embodiment of the grilling and cooking spatula device of the present invention to handle a delicate food item on a grill in accordance with the disclosed architecture; and

FIG. 4 illustrates a perspective view of another potential embodiment of the grilling and cooking spatula device of the present invention in accordance with the disclosed architecture, wherein the device is comprised of a plurality of apertures.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a utensil that allows the users to easily grill food items such as vegetables, meat, beef, chicken, fish, shrimp, pork, etc. There is also a long felt need in the art for a cooking tool that allows the users to handle and manage delicate food items such as fish without worrying about the food item breaking apart during handling while grilling. Additionally, there is a long felt need in the art for a cooking utensil for handling grilled food that prevents the delicate food items from breaking apart while flipping or turning the food items on the cooking grate or while removing the food item from the grate. Moreover, there is a long felt need in the art for a cooking utensil that allows the users to easily transfer the cooked food item from the cooking grill to a serving platter, without the food item separating, thereby preventing any wastage of cooked food. Further, there is a long felt need in the art for a cooking tool that allows the users to quickly cook food and transfer the same onto the serving platter while ensuring the cooked food items looks appealing to the consumers. Furthermore, there is a long felt need in the art for a cooking tool that eliminates the need to use multiple cooking utensils for managing and handling grilled food. Finally, there is a long felt need in the art for a cooking tool that can be used for flipping grilled food items and for transferring cooked food items from the grill to the serving platter easily.

The present invention, in one exemplary embodiment, is a novel grilling and cooking spatula device. The grilling and cooking spatula device is configured to easily slip under, lift and flip delicate food items from a cooking surface. The spatula device further comprises: a handle and a convex arc-shaped or curvilinear spatula plate; the handle is generally cylindrical having a slit on a front side and a pair of ergonomic grips near the ends of the handle for comfortable gripping of the handle; the spatula plate is generally rectilinear in dimensions and includes a continuous curvilinear sheet; the spatula plate includes a pair of longitudinal edges, a top lateral edge and a bottom beveled edge; the top lateral edge is fastened within the handle using rivets allowing use of the spatula plate; and, the bottom beveled edge is used for sliding under a food item placed on a cooking surface allowing the food item to be slid onto the continuous curvilinear sheet.

The handle can be made of a heat-resistant material and the spatula plate can be made of thermostat materials, i.e. stainless steel and aluminum. In one illustrative example, a thermostat spatula plate can comprise a bimetal (“two metal”) strip that is made of two separate metal strips fastened together. For example, a piece of aluminum fastened to a piece of stainless steel. Stainless steel expands less than aluminum as it gets hotter, so the bimetal strip curves inward as the temperature rises. Other common bimetal materials are steel and copper, which can also be fastened together. As the two metals have different coefficients of expansion, any changes in temperature will cause the bimetal strip to bend one way or the other (depending on an increase or decrease in temp).

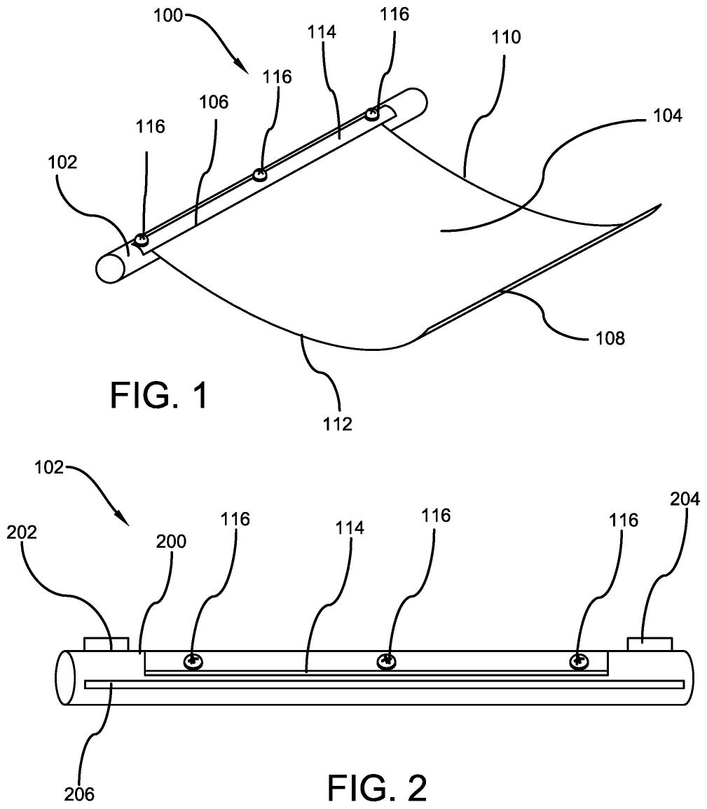

Referring initially to the drawings, FIG. 1 illustrates a perspective view of one potential embodiment of a grilling and cooking spatula device 100 of the present invention in accordance with the disclosed architecture. More specifically, the grilling and cooking spatula 100 is configured and designed to easily flip and transport fish and other delicate food items while grilling and is generally rectangular or square-shaped in configuration. The spatula 100 includes a cylindrical handle 102 and a pre-curved or curvilinear spatula plate 104. The spatula plate 104 is a pre-curved or curvilinear thin and sturdy metal sheet having a pair of longitudinal edges 110, 112, a top lateral edge 106, and a bottom lateral or leading beveled edge 108. The spatula plate 104, in one embodiment, maintains its pre-curved or curvilinear shape when a food item is placed on the plate 104. As described supra, a bimetal construction of the spatula plate will result in further curving of the plate as the plate changes temperature.

The top lateral edge 106 of the spatula plate 104 can be fastened to a slot 114 within the handle 102 using a plurality of mechanical fasteners 116 such as rivets. The mechanical fasteners 116 provide rigidity to the spatula plate 104 and allow same to be easily carried using the handle 102 with stability even when a food item is placed on the spatula plate 104. The bottom lateral beveled leading edge 108 can slide under a food item allowing the food item to slide onto the spatula plate 104 without any damage to the food item. The longitudinal edges 110, 112 provide support to maintain the curved shape of the plate 104. In one embodiment, the spatula plate may have a handle 102 positioned on each end.

The spatula plate 104 can be constructed from a continuous sheet of metal, or bimetals, extending between the longitudinal edges 110,112 and lateral edges 106,108. The bottom beveled leading edge 108 can slide under food items such as a piece of meat or an entire fish, allowing the cook to check its preparedness without needing another spatula or cooking device. The food item can easily be lifted from the grate and flipped using the large surface of the spatula plate 104. The beveled edge 108 slides below the food being cooked, such as a fish seared to the grill, and lifts same in a manner that reduces the chances of separating the food item.

In one potential embodiment, the handle 102 can be generally cylindrical and hollow. The handle 102 includes a pair of comfortable grips 202, 204 on the outer surface and can be made of any thermo-resistant material such as aluminum, stainless steel, cast iron, steel, copper or other metal. It is also contemplated that the handle 102 and/or comfortable grips 202, 204 can be comprised of a silicone in any color and/or shape that suits user need and/or preference. The top edge 106 can be slotted into the cavity 114 for securing the plate 104 to the handle 102. The plate 104 extends longitudinally and orthogonally from the slit of the handle 102. Holes near the top edge 106 of the spatula plate 104 align with the receiving holes in the cavity 114 to secure the plate 104 using rivets 116 passing through the aligned holes.

As described supra, the spatula plate 104, according to the invention, can be pre-curved or curvilinear in structure. The pre-curved or curvilinear arrangement can be constructed as an arc shape such that when the spatula device 100 is placed on a planar surface, such as a table top or grill, the lateral edges 106, 108 do not contact the planar surface and are held in an elevated position while the central portion of the continuous metal sheet remains in contact with the grill or table top. The large surface area afforded by the spatula plate 104 improves the user's ability to handle large and delicate food items without breakage or risk of spillage. The cook or chef can maintain better control over the cooking process through the utilization of the spatula device 100, which provides an improved mechanism for cooking, lifting, and turning large delicate food items on a cooking surface and for transferring and serving the same.

The spatula plate 104 can be made of any resilient heat-compatible material, for example, stainless steel, copper, steel, aluminum, cast iron, etc. The spatula plate 104 eliminates the necessity of using multiple conventional spatulas for cooking large and delicate food items. The spatula plate 104 is easy to clean and can be used on any type of cooking surface.

The spatula plate can have a thickness in the range of about 2.0 mm to about 15.0 mm, for example. In one potential embodiment, the dimensions of the plate can be 8-12 inches (L)×16-20 inches (W, as measured between the handles in a two handled embodiment)×1 cm (H). In another embodiment, the dimensions of the plate can be 10 inches (L)×18 inches (W)×0.8 cm (H). Generally, the length (L) can be from about 6 to about 18 inches, and the width (W) can be from about 14 to about 24 inches to accommodate most food items that would be grilled. The dimensions and thickness described above enables the spatula plate 104 to maintain a rigid curvilinear configuration while moving and cooking food items and while transporting same.

FIG. 2 illustrates a perspective view of a heat-resistant handle 102 of the grilling and cooking spatula device 100 of the present invention in accordance with the disclosed architecture. More specifically, the handle 102 is made of a heat-resistant material and is generally cylindrical in shape. The handle 102 is hollow and includes a cavity/slot 114 with holes therethrough to receive rivets 116 in order to fasten the spatula plate 104 to the handle 102. On the outer surface 200 of the handle 102, two ergonomic grips 202, 204 are present for a user to comfortably hold the handle 102 with both hands while using the spatula device 100.

The spatula plate 104 extends from the handle 102 through a thin groove 206. The groove 206 is present along the length of the handle 102 and is dimensioned in accordance with the thickness of the spatula plate 104. The width of the spatula plate 104 is sized to fit within the cavity 114 of the handle 102. The spatula plate 104 is fastened to the handle and supported along the entire lateral edge 106. A fastening mechanism, for example, rivets 116, can be used to support and fasten the edge 106 within the cavity 114 to hold the spatula plate 104 in a stable manner while in use, and to prohibit undo flexing and twisting of the plate 104.

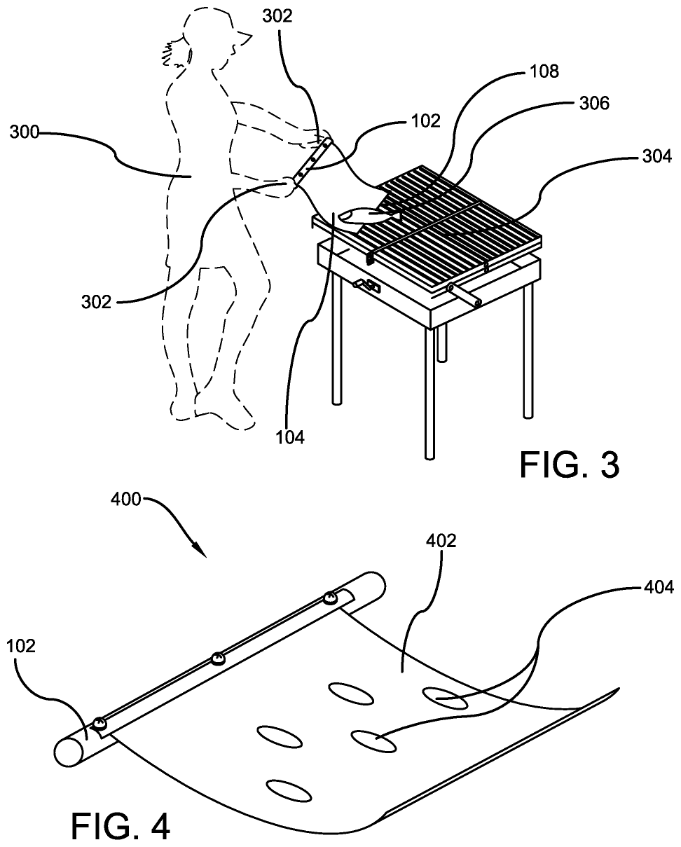

FIG. 3 illustrates a perspective view of a user using one potential embodiment of the grilling and cooking spatula device 100 of the present invention to handle a delicate food item on a grill in accordance with the disclosed architecture. More specifically, a user 300 can hold the spatula device 100 with both hands 302 by using the ergonomics grips 202, 204 near the ends of the handle 102. To lift a food item 306 seared to the grill 304, the user 300 slides the beveled leading edge 108 under the food item 306 such that beveled leading edge 108 touches the grill 304 and slides across the grill bars. Once, the beveled edge 108 is slid under the food item 306 far enough, the food item 306 will become completely supported by the spatula plate 104 thereunder. The user 300 can then lift the spatula device 100, using the handle 102, in order to serve or flip the food item 306 without breakage or risk of spillage.

Alternatively, the spatula plate 104 can be left under the food item for continued cooking. In this manner, the spatula plate 104 becomes the cooking surface underneath the food item. The device 100 can be used for any type of cooking surface and any type of food item. The device 100 can be used to conveniently transfer food from the grill to a serving platter. The device 100 eliminates the necessity of using a pair of spatulas for flipping delicate food items such as a fish.

FIG. 4 illustrates a perspective view of another potential embodiment of the grilling and cooking spatula device 400 of the present invention in accordance with the disclosed architecture, wherein the device 400 is comprised of a plurality of apertures. More specifically, an apertured spatula plate 402 contains several degreasing apertures 404 across the surface of the plate 402 to enable draining of excessive grease and oil from the food. The handle 102 and the fastening mechanism of the plate 402 can be as described supra in the disclosed embodiments of the present invention. The shape and configuration of the apertured plate 402 is similar to the aperture plate of the other embodiments and can include two longitudinal edges and a bottom beveled leading edge for sliding the plate 402 under a food item.

The grilling and cooking spatula devices 100, 400 of the present invention can be used on nonstick cookware, for scraping bowls, griddles, grills, and other types of cooking surfaces. Depending upon materials and dimensions, the plate can hold up to two pounds of food items without any bending. The spatula devices 100, 400 of the present invention include a larger curvilinear food support surface when compared to conventional spatulas and is easy to carry when transporting delicate food items. It is to be appreciated that the spatula plate can slide easily under pancakes and freshly baked cookies.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “grilling and cooking spatula device”, “rectangular plate flipping spatula”, “flipping spatula”, “spatula device”, “spatula” and “device” are interchangeable and refer to the grilling and cooking spatula device 100, 400 of the present invention.

Notwithstanding the forgoing, the grilling and cooking spatula device 100, 400 of the present invention can be of any suitable size, configuration, and material(s) as is known in the art without affecting the overall concept of the invention, provided that it accomplishes the above-stated objectives. One of ordinary skill in the art will appreciate that the size, configurations, and material of the grilling and cooking spatula device 100, 400 as shown in the FIGS. are for illustrative purposes only, and that many other sizes and shapes of the grilling and cooking spatula device 100, 400 are well within the scope of the present disclosure. Although the dimensions of the grilling and cooking spatula device 100, 400 are important design parameters for user convenience, the grilling and cooking spatula device 100, 400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof

What includes been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A spatula device for handling a delicate food item while cooking, the spatula device comprising:
a cylindrical handle including a pair of hand grips and a mounting groove;
a spatula plate fastened to said handle, wherein said spatula plate extends generally orthogonal from said mounting groove in said handle;
said spatula plate includes a length, wherein said spatula plate is curvilinear along said length;
said spatula plate includes a leading edge distal to said handle, wherein said leading edge is beveled, and further wherein said handle and said spatula plate are heat resistant; and
each grip grasped by a hand of a user for sliding said beveled edge under the delicate food item.

2. The spatula device of claim 1, wherein said spatula plate is curvilinear from said handle to said leading edge.

3. The spatula device of claim 2, wherein said spatula plate comprises a material selected from a group consisting of a copper, a steel, a stainless steel, a cast iron, and an aluminum.

4. The spatula device of claim 2, wherein said spatula plate comprises at least two materials selected from a group consisting of a copper, a steel, a stainless steel, a cast iron, and an aluminum.

5. The spatula device of claim 2, wherein said spatula plate comprises a plurality of apertures.

6. The spatula device of claim 3, wherein said material includes a thickness generally from about 2.0 mm to about 15.0 mm.

7. The spatula device of claim 4, wherein said material includes a thickness generally from about 2.0 mm to about 15.0 mm.

8. The spatula device of claim 6, wherein said spatula plate includes said length and a width;
and said length is generally from about 20 cm to about 40 cm, and said width is generally from about 10 cm to about 30 cm.

9. The spatula device of claim 2, wherein said spatula plate is comprised of stainless steel.

10. A spatula device for handling a food item while cooking, the spatula device comprising:
a cylindrical handle including a pair of hand grips and a mounting groove;
a spatula plate fastened to said handle;
said spatula plate extending generally orthogonal from said mounting groove in said handle;
said spatula plate includes a leading edge distal to said handle;
said leading edge is beveled;
said spatula plate includes a length extending from said handle to said leading edge;
wherein said spatula plate is curvilinear along said length;
wherein said handle and said spatula plate are heat resistant;
each grip grasped by a hand of a user for sliding said beveled edge under a cooking food item;
wherein said spatula plate comprises a material selected from a group consisting of a copper, a steel, a stainless steel, a cast iron, and an aluminum;
wherein said material includes a thickness generally from about 2.0 mm to about 15.0 mm; and
wherein said spatula plate includes said length and a width, and said length is generally from about 8 in. to about 12 in., and said width is generally from about 16 in. to about 20 in.

11. The spatula device of claim 10, wherein said spatula plate comprises at least two materials selected from a group consisting of a copper, a steel, a stainless steel, a cast iron, and an aluminum.

12. The spatula device of claim 10, wherein said spatula plate includes a plurality of apertures.

13. A method of using a spatula device for grilling or cooking a delicate food item, the method comprising the steps of:
providing a cylindrical handle including a pair of hand grips and a mounting groove;
fastening a spatula plate to said handle, wherein said spatula plate extends generally orthogonal from said mounting groove in said handle;
forming said spatula plate into a rigid curvilinear structure extending from said handle to a leading edge distal to said handle;
beveling said leading edge, wherein said handle and said spatula plate are heat resistant;
grasping each grip with an opposing hand of a user;
slipping said beveled edge between a cooking surface and the delicate food item; and
sliding said spatula plate underneath the delicate food item between the delicate food item and the cooking surface.

14. The method of claim 13 further comprising a step of flipping the delicate food item.

15. The method of claim 13 further comprising a step of removing said spatula plate and the delicate food item from the cooking surface.

16. The method of claim 13 further comprising a step of leaving said spatula plate between the delicate food item and the cooking surface for an additional cook time.

17. The method of claim 16, wherein said spatula plate comprises a material selected from a group consisting of a copper, a steel, a stainless steel, a cast iron, and an aluminum.

18. The method of claim 16, wherein said spatula plate comprises at least two materials selected from a group consisting of a copper, a steel, a stainless steel, a cast iron, and an aluminum.

19. The method of claim 13 further comprising a step of forming a plurality of apertures in said spatula plate.

20. The method of claim 13, wherein said spatula plate comprises a thickness generally from about 2.0 mm to about 15.0 mm, a length and a width, and further wherein said length is generally from about 10 inches, and said width is generally about 18 inches.
